(19) United States
(12) Patent Application Publication
(10) Pub. No.: US 2008/0126232 A1
(43) Pub. Date: May 29, 2008

(54) System and method for routing Internet transactions from within an organizational network

(76) Inventor: Kevin Lee, New York, NY (US)

Correspondence Address: AMSTER, ROTHSTEIN & EBENSTEIN LLP, 90 PARK AVENUE, NEW YORK, NY, 10016, US

(21) Appl. No.: 11/605,163

(22) Filed: Nov. 28, 2006

(51) Int. Cl. G06Q 40/00; G06F 21/00

(52) U.S. Cl. 705/35; 726/12

(57) ABSTRACT

A method for receiving credit for revenue generating activities conducted on one or more designated Internet domains through an organization's internal network includes the steps of: detecting that a user of the internal network has requested access to one of the designated domains; routing user access to the designated domain; sending a signal indicating at least one of the user's access of and request to access the designated domain; and receiving at least partial credit for the at least one of the user's access and request to access the designated domain. In at least one embodiment, user access is routed to the designated domain through a proxy server.

### FIELD OF THE INVENTION

The present invention generally relates to systems and methods for routing Internet transactions, and in particular to systems and methods for routing Internet transactions from within an organizational network.

### BACKGROUND OF THE INVENTION

Internet-based referral reward systems are well known in the art, and such systems often use a tracking system to determine which associates have earned credit for referring a customer. Within the art, the term “associate” is often used interchangeably with the term “affiliate”. As an example of such systems, U.S. Pat. No. 6,029,141 to Bezos et al. (“the '141 patent”) discloses an Internet-based referral system that enables individuals and other business entities, referred to as “associates”, to market products that are sold from a merchant's Web site in return for a commission. According to the '141 patent, when a customer clicks on a referral link on an associate's website, information is sent to the merchant regarding the referring associate. Similarly, U.S. Patent Application Publication No. 2002/0069146 to Huang et al. discloses a method of processing referral fees for accessing a server computer via media player modules. Further, U.S. Patent Application Publication No. 2003/0088465 to Monteverde discloses a method of internet-based advertising including providing an advertiser enrollment system and an advertiser's associate enrollment system that allows web site owners to electronically operate as advertiser's associates that refer customers to the advertiser's web site in exchange for compensation.

Although the concept of providing credit to Internet-based merchant-associates/affiliates as compensation for advertising or referring a customer to the merchant is known, the present systems are not able to function within a specific network to allow individual network users limited access to Internet merchants so that a network owner can receive credit for allowing such access. For example, the prior art does not address the issue of multiple users of a single network accessing one or more merchant domains, and does not provide for an efficient means for tracking access to the merchant domains from within the network for the purpose of attributing credit to the network owner.

Accordingly, it is an object of the present invention to provide a system and method for crediting an organizational network for allowing a user of the network to access and conduct commercial transactions on an external reward domain, and to provide efficient tracking of such access.

### SUMMARY OF THE INVENTION

A method for receiving credit for revenue generating activities conducted on one or more designated Internet domains through an organization's internal network according to an exemplary embodiment of the present invention comprises the steps of: detecting that a user of the internal network has requested access to one of the designated domains; routing user access to the designated domain; sending a signal indicating at least one of the user's access of and request to access the designated domain; and receiving at least partial credit for the at least one of the user's access and request to access the designated domain.

A method for crediting one or more designated organizations with revenue generating activities conducted by users of the one or more designated organizations' associated networks on an Internet domain according to an exemplary embodiment of the present invention comprises the steps of: receiving a signal from one of the users of a network requesting user access to the Internet domain; providing at least partial access to the domain; tracking at least one of the user's access of and request to access the Internet domain; and providing at least partial credit to the organization for the tracked at least one of the user's access and request to access the designated domain.

A system for receiving credit for revenue generating activities conducted on one or more designated Internet domains through an organization's internal network according to an exemplary embodiment of the present invention comprises a domain name system for detecting that a user of the internal network has requested access to one of the designated domains; a proxy server, a router or a gateway for routing user access to the designated domain; and a click-tracking server for detecting that a user of the internal network has accessed the designated domain through the proxy server or from the router or gateway, so that the user receives at least partial credit for the at least one of the user's access and request to access the designated domain through the proxy server or from the router or gateway.

According to an exemplary embodiment of the present invention, a computer readable medium has computer executable instructions for performing a method for receiving credit for revenue generating activities conducted on one or more designated Internet domains through an organization's internal network, where the method comprises the steps of: detecting that a user of the internal network has requested access to one of the designated domains; routing user access to the designated domain; sending a signal indicating at least one of the user's access of and request to access the designated domain; and receiving at least partial credit for the at least one of the user's access and request to access the designated domain.

In at least one embodiment of the present invention, user access is routed to the designated domain through a proxy server.

These and other features of this invention are described in, or are apparent from, the following detailed description of various exemplary embodiments of this invention

### BRIEF DESCRIPTION OF THE DRAWINGS

Various exemplary embodiments of this invention will be described in detail, with reference to the following figures, wherein:

FIG. 1 shows a system for routing Internet transactions to receive and distribute credit for revenue generating activities according to an exemplary embodiment of the present invention;

FIG. 2 shows a system for routing Internet transactions to receive and distribute credit for revenue generating activities according to another exemplary embodiment of the present invention;

FIG. 3 is a flow chart illustrating a method for routing Internet transactions to receive and distribute credit for revenue generating activities according to an exemplary embodiment of the present invention; and

FIG. 4 shows a system for routing Internet transactions to receive and distribute credit for revenue generating activities according to another exemplary embodiment of the present invention.

### DETAILED DESCRIPTION OF PREFERRED EMBODIMENTS

Various exemplary embodiments of the present invention are directed to a system and method for routing transactions over the Internet to receive and distribute credit for revenue generating activities that originate from within a network and that are conducted at an Internet domain (hereinafter referred to as a “reward domain”). Although the present disclosure refers to revenue generating activities that originate within an intranet, it should be appreciated that the revenue generating activities may originate from within any other network structure, such as, for example, a personal area network, a wide area networks (WAN), a local area networks (LAN), an extranet, or an Internet service provider (ISP). The common element is that the network is controlled by the entity wishing to receive credit for transactions originating from within the network.

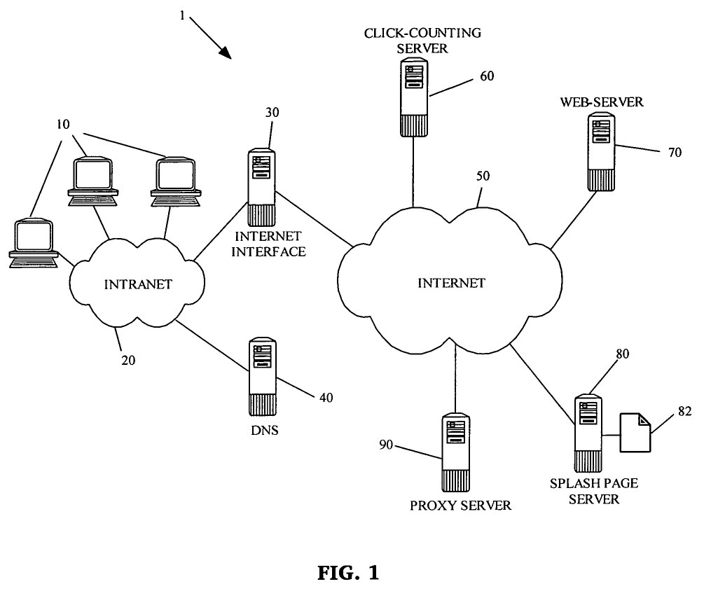

FIG. 1 shows a routing system, generally designated by reference number 1, according to an exemplary embodiment of the present invention. The routing system 1 includes one or more personal computer workstations 10 connected through an intranet 20. The intranet 20 may be a private computer network for an organization, in which case the computer workstations 10 would allow users to access and share at least part of the organization's information and/or operations over the intranet 20. The intranet 20 further includes an Internet interface 30, which may include, for example, a firewall, proxy and/or router to allow users at least limited access to the Internet on the computer workstations 10. The granted Internet access would allow users to interact with content stored on a web server 70.

A domain name system (DNS) 40 stores and associates many types of information with domain names, including translation of domain names to Internet Protocol (IP) addresses. As explained in further detail below, the DNS 40 causes traffic between the computer workstations 10 and certain Internet domains to route through a proxy server 90 by specifying that the IP address for the reward domains are the same as the IP address for the proxy server 90. The proxy server 90 thus acts to serve all the pages from a set of domains to the browsers on the computer workstations 10. The proxy server 90 and DNS 40 may be configured to limit access of the users of the intranet 20 to a pool of selected entities, such as, for example, merchants, publishers, marketers and agents, that have reward domains, and in exchange the organization may be designated the beneficiary of loyalty rewards granted by the selected entities as a result of the users interactions with the reward domains. In this regard, the users may generate loyalty rewards for the organization by engaging in commercial transactions with the selected reward domains, or by engaging in other revenue generating activities such as registration on Internet websites or interacting with advertising links associated with the reward domains. The organization may be designated as the revenue recipient directly or through a revenue sharing arrangement with a third-party administrator.

According to an exemplary embodiment of the present invention, the proxy server 90 may track user access to reward domains by redirecting a user through a click-tracking server 60 at some point after the user requests access to a reward domain. The redirect may occur immediately upon initial request of the domain or at any point during user access of the domain. As is known in the art, click-tracking servers are third party servers used by an owner of a domain to track how many times a particular link is clicked, as well as to set tracking sessions or tracking cookies on each user interacting with a particular link. Within each link is embedded information related to the identification of the organization(s) to be credited for subsequent transactions subject to agreements in place for such purpose for reference by the third-party server owner and the domain owner. One or more click-tracking servers may be used in conjunction to provide redundancy in tracking. Although the click-tracking server 60 is shown separate from the proxy server 90 in FIG. 1, it should be appreciated that the click-tracking server 60 may be on the same piece of hardware as the proxy server 90. The proxy server 90 may provide an immediate redirect to the click-tracking server 90, or instead temporarily substitute a splash page 82 by redirecting through a splash-page server 80 before the user arrives at the click-tracking server 90. The splash page 82 may provide a notification or warning and/or allow for a continuation through the click-tracking server to the requested domain by either clicking on a link to the click-tracking server 90 or a meta refresh that automatically redirects to the click-tracking server 90 after a brief interval. The DNS 40 may reside either within the intranet, within the Internet interface or within the Internet. Similarly, although the DNS 40 and the proxy server 90 are shown separate from the Internet interface 30, all the functions may be combined within the same piece of hardware.

The proxy server 90 may use an internal look-up table that provides the logic required for the proxy server to determine whether to redirect the user to the splash-page server and/or click-tracking server, or allow the user to access a requested domain transparently. It should be appreciated that, in other embodiments of the present invention, access may be routed through a gateway or router where routing decisions are executed through supplemental programming. In this regard, a regular expression may be applied to the initial URL request, and the look-up table may include information on whether to redirect to or bypass the click-tracking server 60 based on, for example, regular expression matching, such as, for example, root domain matching, domain URL structure, referrer, the existence of a cookie on the user computer or the IP address of the requested network. Preferably, the proxy server 90 should route page requests back to the primary URL's true destination upon successful redirect of the user through the click-tracking server 60 during a single user session. Thus, the look-up table may indicate that if the prior domain requested before a target domain was already a click-tracking URL, then the target domain should be accessed transparently. Generally, a click-tracking server sets a cookie on the user computer for sufficient time to make additional redirects through the tracking server unnecessary within a specified period of time (for example, users would only need to be redirected once per day for a repeated domain request). Table 1 below is an exemplary portion of a look-up table useable with the proxy server 90 according to an exemplary embodiment of the present invention.

TABLE 1

| | EXCLUSION | | | SHOW |
|---|---|---|---|---|
| REQUESTED | REGULAR | SPLASH PAGE | CLICK-TRACKING | SPLASH |
| URL | EXPRESSION | URL | SERVER URL | PAGE? |
| www.vendor1.com | If prior requested | spserver1.com/vendor1 | ctserver1.com/clickid=1234 | no |
| | domain was | | | |
| | spserver1.com, | | | |
| | then bypass click- | | | |
| | tracking server. | | | |
| *.vendor2.com | If URL includes | spserver2.com/vendor2 | ctserver2.com/affid=123 | yes |
| | affid=*, then | | | |
| | bypass click- | | | |
| | tracking server | | | |
| www.vendor3.com/ | If URL includes | Spserver1.com/vendor3 | Ctserver1.com/affid=321 | yes |
| checkout.cgi | affid=*, then | | | |
| | bypass click- | | | |
| | tracking server | | | |

The same proxy server may service more than once organization's network, in which case the click-tracking server URLs and potentially the targeted URL list may be different for each organization. Thus, each organization preferably has the ability to construct their own look-up table to allow for customization of domains and exclusions. The proxy server may determine which of the look-up tables to use based on the requesting IP address, since each organization would typically have a set group of routers/firewalls with IP addresses within a specific range associated with those routers/firewalls. If organizations can not predict their IP address range, the proxy server may be set to provide a menu for organizations from which a user may select in order to assure appropriate credit to the organization. An administrative interface for each organization may be provided on the proxy server 90 to facilitate the edits of IP blocks/organizations, as well as the splash page URLs and click-tracking URLs, minimizing the use of the user menu for unidentifiable users.

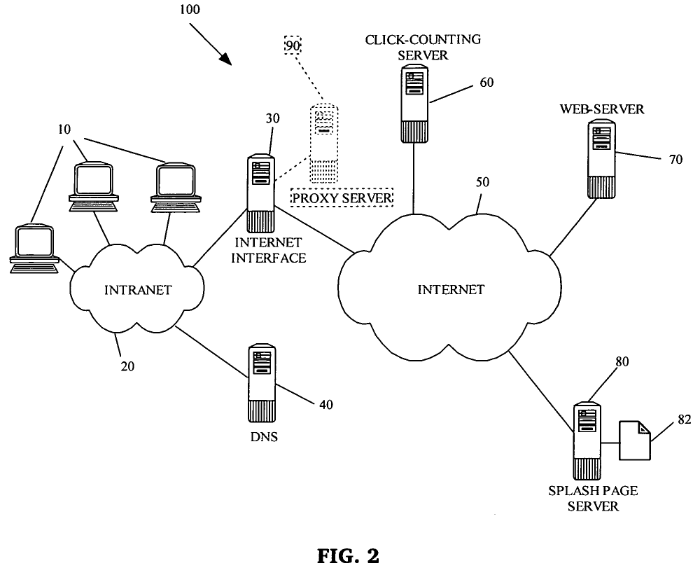

FIG. 2 shows a routing system, generally designated by reference number 100, according to another exemplary embodiment of the present invention. The system 100 has the same components as in the previous embodiment, except that the proxy server 90 is part of the Internet interface 30 disposed within the intranet 20. Thus, as an example, the proxy server 90 may be disposed inline with a router and/or firewall within the intranet.

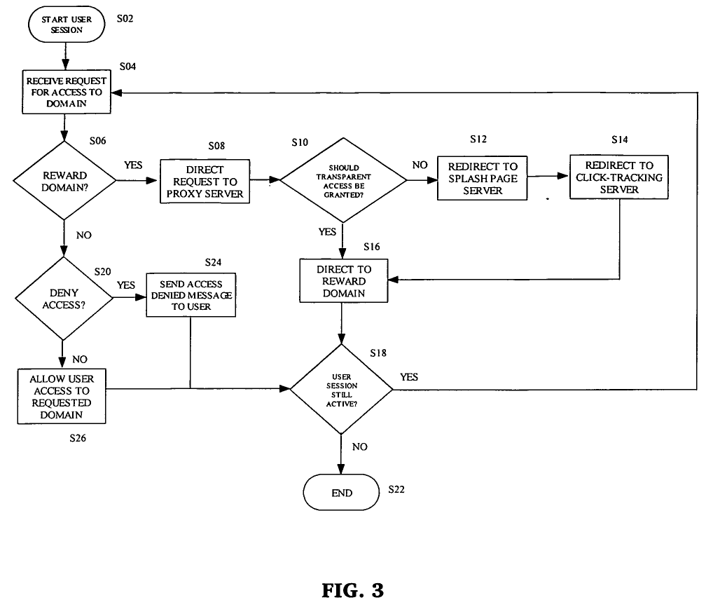

FIG. 3 is a flow chart illustrating a method for routing Internet transactions to receive and distribute credit for revenue generating activities according to an exemplary embodiment of the present invention. In step S02, the network determines that a user has begun a user session by, for example, receiving user input log in information from a network computer or receiving a DNS lookup request. In step S04, the network DNS determines whether the requested domain is a rewards domain, meaning that the request should be rerouted to the proxy server 90. If the requested domain is not a rewards domain, then the process would generally allow unfettered access to the domain by providing the normal externally recognized IP address for the domain. It would be possible to deny user access to the requested domain by either routing the user to an “access denied” splash page, or by refusing to provide an IP address response resulting in a user error. In this regard, if access is denied, an access denied message may be displayed on the user's computer at step S20. If thus configured, the access denied page displayed on the user's computer may recommend alternate participating reward domains, serve similar content directly at the splash page domain or substitute an alternate domain. Otherwise, user access to the requested domain is granted through the proxy server for a reward domain. Thus, in the present embodiment, the organization network may be configured such that users may only gain access to reward domains through the proxy server, and not to any other domains. However, it should be appreciated that the network may be configured such that users have access to all or only some domains, and only the reward domains are serviced through the proxy server.

In step S06, if it is determined that the requested domain is a reward domain, then the process will continue to step S08, where the request is directed to the proxy server 90. In step S10, the proxy server 90 determines whether transparent access to the requested domain should be granted to the user or whether the user should be redirected either to the splash-page server 80 or through the click-tracking server 60 directly without the interim step of the splash page. In this regard, as discussed above, the proxy server 90 may perform regular expression matching of the requested domain with the information provided in a look-up table to determine the appropriate action.

In step S10, if it is determined that transparent access should not be granted, the process continues to step S12, where the proxy sever 90 redirects the user to the splash-page server 80 or through the click-tracking server 60 directly without the interim step of the splash page. The splash-page server 80 may provide a warning along with a link or meta refresh to the click-tracking server 60. In step S14, clicking on the link or the meta refresh redirects the user to the click-tracking server 60, where the user's access to the requested reward domain is tracked so that the organization may receive credit. Alternatively, the splash-page server 80 may be eliminated so that the user is redirected though the click-tracking server 60 without the use of a splash page. From either steps S10 or S14, the process continues to step S16, where the user is provided transparent access to the reward domain.

From either steps S20 or S16, the process continues to step S18, where the network or proxy server 90 determines whether the user session is still active as defined within the system as a period of time since last access or alternatively by the existence of a cookie. If the user session is still active, the process returns to step S04, where the network receives further requests from the user to access a domain. Tracking whether a particular user session is still active may be useful information in determining whether transparent access to a requested domain should be granted or whether a new redirect through the tracking server 60 or splash page server 80 is required. For example, directing the user to the reward domain through the click-tracking server may not be necessary once the organization has received credit for allowing the user to access the reward domain during a single user session. In step S18, if it is determined that the user session is no longer active, the process ends at step S22.

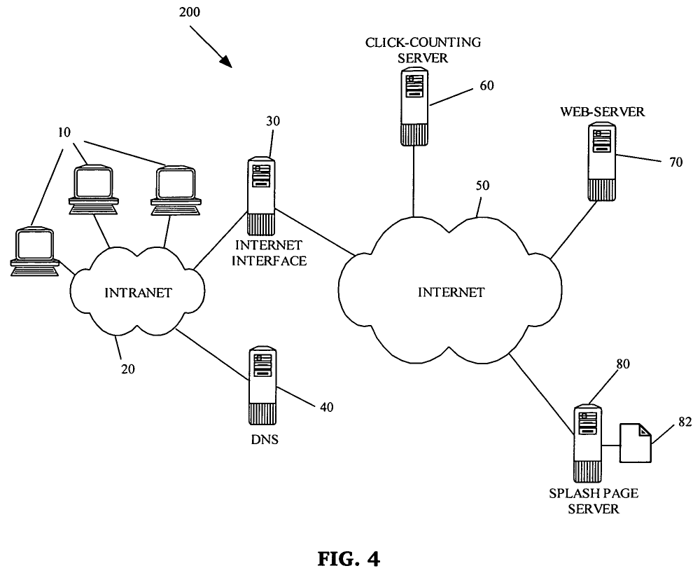

In an alternative embodiment, the routing system according to the present invention may route user access to a designated domain without the use of a proxy server. For example, FIG. 4 shows a routing system, generally designated by reference number 200, according to an exemplary embodiment of the present invention, having the same components as those used in the routing system 100, except that the proxy server 90 is excluded. In this embodiment, the Internet interface 30 may include imbedded logic which performs the functions of determining whether transparent access to the requested domain should be granted to the user or whether the user should be redirected either to the splash-page server 80 or through the click-tracking server 60 directly without the interim step of the splash page, and then routing the user accordingly.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A method for receiving credit for revenue generating activities conducted on one or more designated Internet domains through an organization's internal network, comprising the steps of:
detecting that a user of the internal network has requested access to one of the designated domains;
routing user access to the designated domain;
sending a signal indicating at least one of the user's access of and request to access the designated domain; and
receiving at least partial credit for the at least one of the user's access and request to access the designated domain.

2. The method of claim 1, wherein user access is routed to the designated domain through a proxy server.

3. The method of claim 2, wherein the step of sending a signal comprises the step of determining whether to redirect the at least one of the user's access and request to access the designated domain to a click-tracking server.

4. The method of claim 3, wherein the step of sending a signal comprises the step of determining whether to redirect the at least one of the user's access and request to access the designated domain to a splash-page server that generates a splash page including a link to the click-tracking server.

5. The method of claim 3, wherein the click tracking server is remote from the proxy server.

6. The method of claim 3, wherein the click tracking server and the proxy server are located on same hardware.

7. The method of claim 4, further comprising the step of providing a database including information associated with the plurality of designated domains.

8. The method of claim 7, wherein the step of determining whether to redirect to the click-tracking server and the step of determining whether to redirect to the splash-page server are based on the information associated with the one designated domain contained in the database or information obtained from a user computer.

9. The method of claim 8, wherein the information associated with the plurality of designated domains includes one or more of the following: the associated splash page server URL, the associated click-tracking server URL, and associated conditions that exclude redirection to the associated splash page server.

10. The method of claim 2, wherein the proxy server is disposed within the organization's internal network.

11. The method of claim 2, wherein the proxy server is external to the organization's internal network.

12. The method of claim 7, wherein the database is disposed within the organization's internal network.

13. The method of claim 7, wherein the database is external to the organization's internal network.

14. The method of claim 1, further comprising:
detecting that a user of the internal network has requested access to a domain that is not one of the designated domains; and
redirecting the user's request to access the domain that is not one of the designated domains to a splash-page server.

15. A method for crediting one or more designated organizations with revenue generating activities conducted by users of the one or more designated organizations' associated networks on an Internet domain, comprising the steps of:
receiving a signal from one of the users of a network requesting user access to the Internet domain;
providing at least partial access to the domain;
tracking at least one of the user's access of and request to access the Internet domain; and
providing at least partial credit to the organization for the tracked at least one of the user's access and request to access the designated domain.

16. The method of claim 15, wherein at least partial access to the domain is provided through a proxy server.

17. The method of claim 15, wherein the step of tracking comprises generating a splash page that contains a link to a click-tracking server.

18. The method of claim 15, wherein the step of tracking comprises immediately routing traffic through a click-tracking server prior to providing access to the Internet domain.

19. The method of claim 15, wherein the step of tracking comprises routing traffic through a click-tracking server upon user request of a specific page on the Internet domain.

20. A system for receiving credit for revenue generating activities conducted on one or more designated Internet domains through an organization's internal network, comprising:
a domain name system for detecting that a user of the internal network has requested access to one of the designated domains;
a proxy server, a router or a gateway for routing user access to the designated domain; and
a click-tracking server for detecting that a user of the internal network has accessed the designated domain through the proxy server or from the router or gateway, so that the user receives at least partial credit for the at least one of the user's access and request to access the designated domain through the proxy server or from the router or gateway.

21. The system of claim 20, wherein the click tracking server and the proxy server are located on same hardware.

22. The system of claim 20, further comprising a splash-page server that generates a splash page including a link to the click-tracking server.

23. The system of claim 21, wherein the click tracking server is remote from the proxy server.

24. The system of claim 22, wherein the click tracking server and the proxy server are located on same hardware.

25. The system of claim 20, wherein the proxy server is disposed within the organization's internal network.

26. The system of claim 20, wherein the proxy server is external to the organization's internal network.

27. The system of claim 20, wherein the domain name system is disposed within the organization's internal network.

28. The system of claim 20, wherein the domain name system is external to the organization's internal network.

29. A computer readable medium having computer executable instructions for performing a method for receiving credit for revenue generating activities conducted on one or more designated Internet domains through an organization's internal network, the method comprising the steps of:
detecting that a user of the internal network has requested access to one of the designated domains;
routing user access to the designated domain;
sending a signal indicating at least one of the user's access of and request to access the designated domain; and
receiving at least partial credit for the at least one of the user's access and request to access the designated domain.

30. The computer readable medium of claim 29, wherein user access is routed to the designated domain through a proxy server.

31. The computer readable medium of claim 30, wherein the step of sending a signal comprises the step of determining whether to redirect the at least one of the user's access and request to access the designated domain to a click-tracking server.

32. The computer readable medium of claim 31, wherein the step of sending a signal comprises the step of determining whether to redirect the at least one of the user's access and request to access the designated domain to a splash-page server that generates a splash page including a link to the click-tracking server.

33. The computer readable medium of claim 31, wherein the click tracking server is remote from the proxy server.

34. The computer readable medium of claim 31, wherein the click tracking server and the proxy server are located on same hardware.

35. The computer readable medium of claim 32, further comprising the step of providing a database including information associated with the plurality of designated domains.

36. The computer readable medium of claim 35, wherein the step of determining whether to redirect to the click-tracking server and the step of determining whether to redirect to the splash-page server are based on the information associated with the one designated domain contained in the database or information obtained from a user computer.

37. The computer readable medium of claim 35, wherein the information associated with the plurality of designated domains includes one or more of the following: the associated splash page server URL, the associated click-tracking server URL, and associated conditions that exclude redirection to the associated splash page server.

38. The computer readable medium of claim 30, wherein the proxy server is disposed within the organization's internal network.

39. The computer readable medium of claim 30, wherein the proxy server is external to the organization's internal network.

40. The computer readable medium of claim 35, wherein the database is disposed within the organization's internal network.

41. The computer readable medium of claim 35, wherein the database is external to the organization's internal network.
